(19) United States
(12) Patent Application Publication
(10) Pub. No.: US 2010/0100383 A1
(43) Pub. Date: Apr. 22, 2010

(54) SYSTEM AND METHOD FOR SEARCHING WEBPAGE WITH VOICE CONTROL

(75) Inventors: TSUNG-HAN TSAI, Taipei City (TW); CHEN-WEI SU, Taipei City (TW); CHUN-PING FANG, Taipei City (TW); MIN-CHING WU, Taipei City (TW)

Correspondence Address: AIBELIVE CO., LTD., P.O. BOX 108-00403, TAIPEI, 106, TW

(73) Assignee: AIBELIVE CO., LTD., Taipei City (TW)

(21) Appl. No.: 12/253,242

(22) Filed: Oct. 17, 2008

(51) Int. Cl. G10L 15/18; G10L 15/00

(52) U.S. Cl. 704/257; 704/E15.001

(57) ABSTRACT

The present invention relates to a system and method for searching webpage by voice control. After an explorer opens a webpage, a natural language processing module searches a plurality of texts and hyperlinks in the webpage and remarks them with numbers and colors, and generates a constructive concept script representing them after analyzing the text, the hyperlink and the remarks. The constructive concept script and the corresponding linking commands can be stored in the database. The user only has to speak out the number, color or keyword, the system receives the user's voice signal by a sound receiving device and generates the constructive concept script by a voice identification module in order to match with a plurality of constructive concept script stored in the database, and execute the command of the resulting match. Thus, the user can directly say the number, color or keyword, the explorer will link to the desired webpage accordingly. Because the operation in the explorer is convenient and prompt, the user can retrieve the desired webpage in a shorter time.

### BACKGROUND OF THE INVENTION

1. Field of the Invention

The present invention relates to a system and method for searching a webpage by voice control, and more particularly to a system and method for searching a webpage linking by remarking a plurality texts and hyperlinks by user's vocal execution, in order to simplify operation procedure.

2. Description of Related Art

Computers are popularly used everywhere due to well developed computer and internet technologies. The features of the internet enable the user to search various information over the internet in the daily life. Generally speaking, to start using the internet, the explorer is executed to open a webpage, and the information is displayed on the webpage. However, because a variety of information is plenty and the content is vast, the user has to spend a lot of time to search and view the desired information.

To resolve the above problems, some proposed to classify the information in order to separate and store the vast information into different pages, and use the hyperlink to format the homepage with simple classifications and outlines to enable the user to search and view the specific information in a comparatively shorter time. However, the information and functions in the webpage are continuously increasing, a large amount of hyperlink appears in the homepage, which are also correspondingly increasing and would load more and more hyperlinks into the limited space of the webpage. This will minimize the space of the hyperlink and the unused space between hyperlinks, thus the user accordingly has to spend a lot of time not only in searching and viewing the information, but also needs to control the mouse and cursor to click on the hyperlink. In other words, the above defects are that the user has to move the cursor several times to hit the hyperlink, and these several times movements may not accurately hit the right hyperlink.

The present webpage searching method by the explorer has defects, for example, the user may not be able to easily hit a hyperlink or the user may hit a wrong hyperlink while using the mouse to move the cursor, the user has to use the mouse to control the cursor few times to return to the previous page for clicking onto the right hyperlink, which is unnecessarily wasting time.

The above method of viewing webpage by using the explorer indeed has defects; and therefore, how to solve the above defects has become an important issue for the manufacturers in the field.

### SUMMARY OF THE INVENTION

An object of the present invention is to provide a system and a method for searching webpage by voice control.

According to an aspect of the present invention, the system remarks the plurality texts and hyperlinks of the webpage linked by the explorer, designates a number to the hyperlink, which is displayed at a side or provide a background color to the hyperlink. The user only need to speak out the number, the color or keyword of the desired hyperlink and the system will automatically link to the webpage of the hyperlink. Because the user need not move the mouse to control the cursor for clicking on the hyperlink, the problem of missing to click on the right hyperlink among all hyperlinks with undersized gaps can be resolved, and the operation time consumed can be accordingly reduced.

According to another aspect of the present invention, the keyword is analyzed and particular keyword is remarked with color before remarking the plurality texts and hyperlink of the webpage, thus the user need not finish reading the whole article when searching for the plurality texts in the webpage, the user merely speak out the keyword while searching or even before searching, the webpage can automatically link to the hyperlink webpage corresponding to the keyword. Thus the webpage browsing speed can be faster, and the user need not keep looking at the monitor and strain the eyes.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of a system for searching webpage according to a preferred embodiment of the present invention.

FIG. 2 is a flowchart illustrating a method using a system for searching webpage according to a preferred embodiment of the present invention.

FIG. 3 is a flowchart illustrating a method of processing analysis by the natural language processing module according to another embodiment of the present invention.

FIG. 4 is a flowchart illustrating a method of processing matching by the natural language processing module according to another embodiment of the present invention.

### DETAIL DESCRIPTION OF THE INVENTION

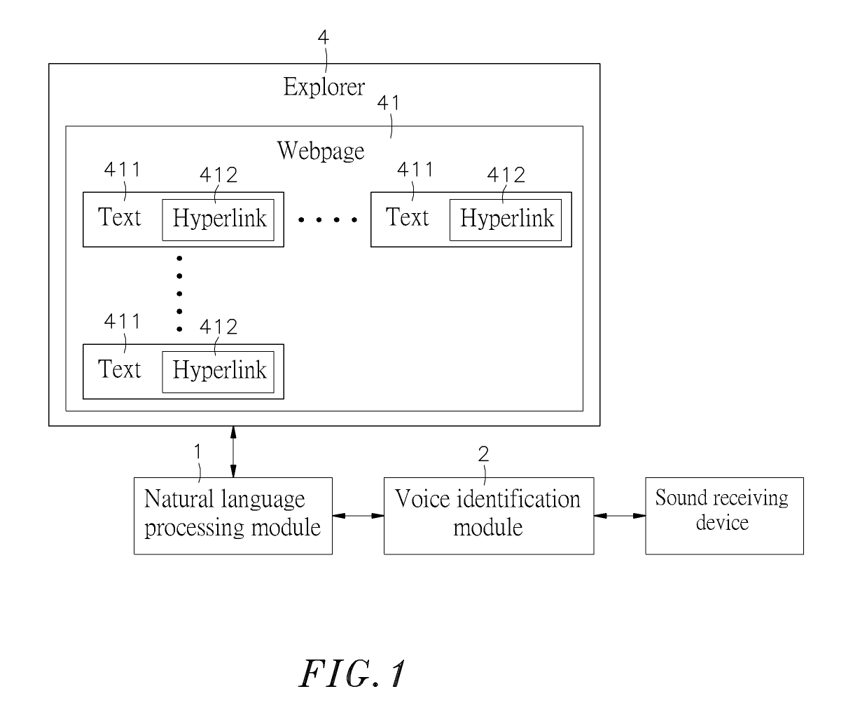

FIG. 1 is a block diagram of a system for searching webpage according to an embodiment of the present invention, which comprises a natural language processing module 1 connected to a voice identification module 2, and a sound receiving device 3 for receiving the user's voice signal is received by the voice identification module 2. The natural language processing module 1 is also connected to an explorer 4 for opening a webpage 41. The webpage 41 comprises a plurality of texts 411 and a hyperlink 412.

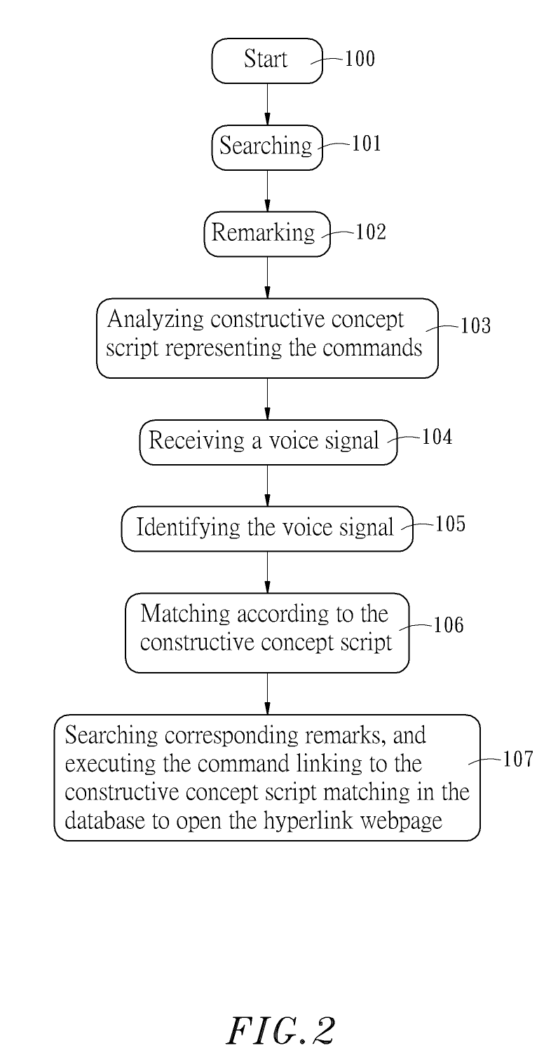

FIG. 2 is a flowchart illustrating a method using a system for searching webpage according to a preferred embodiment of the present invention, which comprises the following process steps.

At step 100, the system is started.

At step 101, a plurality of texts with hyperlink on a webpage is searched.

At step 102, the texts with hyperlink are remarked.

At step 103, the constructive concept script representing the commands is analyzed.

At step 104, a voice signal is received.

At step 105, the voice signal is identified.

At step 106, matching is performed according to the constructive concept script.

At step 107, corresponding remarks are searched, and the command linking to the constructive concept script matching in the database is executed to open the hyperlink webpage.

The system can be initiated when the explorer 4 opens the webpage 41. The system starts searching the plurality of texts 411 with the hyperlink 412 on the webpage 41 and remarks them. Next, the natural language processing module 1 starts to generate a constructive concept script after analyzing the plurality of texts 411, and the corresponding numbers and colors and links up to the hyperlink 412 contained in the plurality of texts 411 for executing the command by the constructive concept script. The constructive concept script and the linking command can be stored in the database.

The sound receiving device 3 can receive the voice signal when the user speaks out, and the voice signal is transmitted to the voice identification module 2 for identification. The voice signal is converted into text information for the natural language processing module 1 to analyze and convert it into a constructive concept script. The voice constructive concept script is matched with every constructive concept script in the database for executing the link command of the resulted constructive concept script in the database. Thus, the explorer 4 would be able to link to the new page of the hyperlink 412 from the original page of the webpage 41.

Thus, the method includes searching the plurality of texts 411 having the hyperlink 412 in the webpage 41 and remarking them with number, which is displayed on a side of the plurality of texts 411 and or designate a background color of the plurality of texts 411. The remark sequence can be from left to right or from top to bottom or along X or Y coordinates. One single the text 411 can be remarked with both number and the color simultaneously, or the plurality of texts 411 can be remarked either with number or color, and the remark sequence can be a predetermined number first and then color, or the predetermined color first and then the number, or remarking with number and color alternatively. The above description is illustrated to only remark the plurality of texts 411 with the hyperlink 412 for differentiation, and is not intended to limit the scope of the present invention. Any modification and variations would be construed to be within the spirit and scope of the present invention.

The user may speak out the number or color for voice identification. Next, the voice signal can be matched with every constructive concept script in the database for further executing clicking on the hyperlink 412 remarked by the number or color. Thus, another the webpage 41 can be linked from the webpage 41 in the explorer 4 according to the user's desire. Because the user need not move the mouse to move the cursor to the text 411 for clicking on the hyperlink 412, the user can enjoy the convenience of surfing in the webpage 41.

Furthermore, the system builds up a constructive concept script by analyzing the texts 411 and designating number or color via the natural language processing module 1. If the texts 411, for example, news, advertisement, search result, article or other types, contain keyword, the user can speak out the keyword, the voice identification and matching for searching the constructive concept script containing the text 411 with the same keyword in the database. Conventionally, because the webpage 41 usually contains the plurality of texts 411 and the hyperlinks 412 and the user has to spend a lot of time to view them and stain the eyes, it substantially takes a lot of time to hit the right text 411 from the plurality of hyperlinks 412. To use the above described method of the present invention, the user only need to speak out the keyword of the text 411, the explorer 4 links to the every text 411 and the hyperlink 412 through the webpage 41. The user can also speak out the keyword before viewing the detailed text 411 and the hyperlink 412 displayed in the webpage 41, and the webpage 41 directly links to the required page to accordingly save the operation time, as well as to promote the convenience for exploring, operating and using the webpage 41.

The system of the present invention not only provides the user to speak out the keyword contained in the text 411 to execute the hyperlink 412 of the text 411 displayed in the webpage 41, but also the means to search the keyword by analyzing the text 411 through the natural language processing module 1 to mark colors in the background of the keyword while processing remarking. The remark can be numbers if the keyword is repeated. Furthermore, besides enabling the user to search a particular subject from the plurality of texts 411, speaking out the keyword substantially can increase the speed for matching constructive concept script in the database after the voice identification.

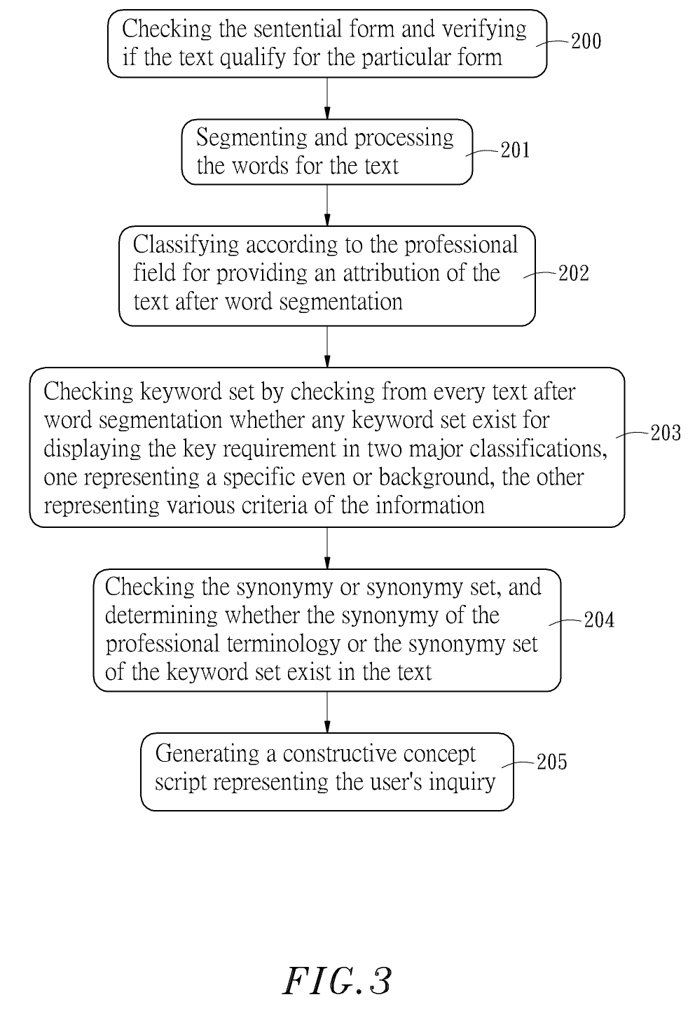

FIG. 3 is a flowchart illustrating a method of processing analysis by the natural language processing module according to another embodiment of the present invention. The process of analyzing the text 411 by the software of the natural language processing module 1 comprises the following steps.

At step 200, the sentential form is checked and verified if the text 411 qualify for the particular form.

At step 201, the words are segmented and processed for the text 411.

At step 202, classifying according to the professional field for providing an attribution of phrases after word segmentation, for example to classify as terminologies, common phrases or verbs.

At step 203, keyword set is checked by checking from every phrases after word segmentation whether any keyword set exist for displaying the key requirement in two major classifications, one representing a specific even or background, the other representing various criteria of the information.

At step 204, the synonymy or synonymy set is checked, and whether the synonymy of the professional terminology or the synonymy set of the keyword set exist in the text 411 is determined.

At step 205, a constructive concept script representing the user's inquiry is generated.

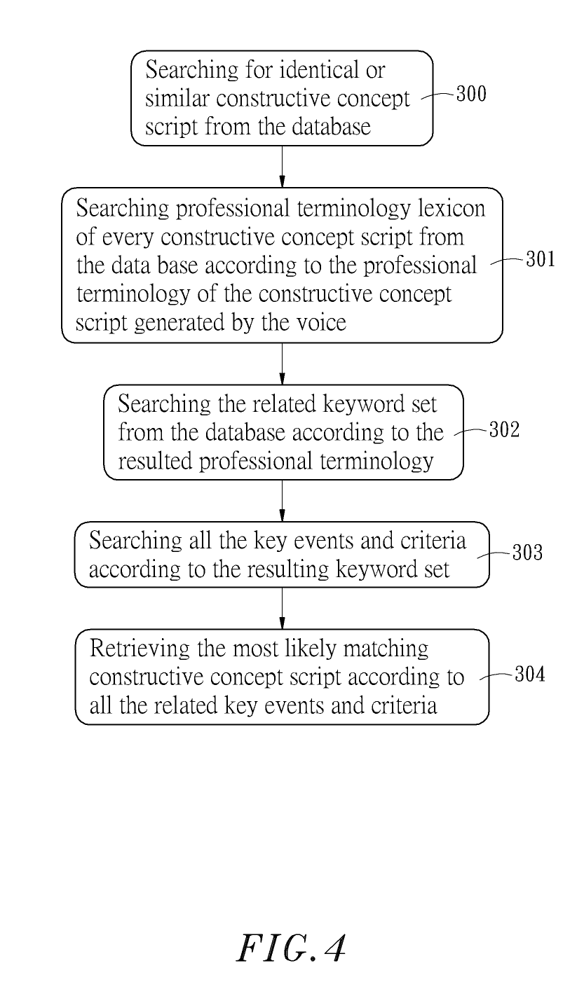

FIG. 4 is a flowchart of a method for processing matching by the natural language processing module according to another embodiment of the present invention. The method of matching of the constructive concept script generated by the natural language processing module 1 after identifying the user's voice with every constructive concept script in the database comprises the following steps.

At step 300, identical or similar constructive concept script is searched from the database.

At step 301, professional terminology lexicon of every constructive concept script is searched from the data base according to the professional terminology of the constructive concept script generated by the voice.

At step 302, the related keyword set is searched from the database according to the resulted professional terminology.

At step 303, all the key events and criteria are searched according to the resulting keyword set.

At step 304, the most matching constructive concept script is retrieved according to all the related key events and criteria.

In the step of searching for the above constructive concept script, after searching for the professional terminology, search for synonymy of the specific professional terminology is continued. After searching the resulting the keyword set, search for the synonymy set of the keyword set carried out in order to promote the accuracy. The above subject, arrangement, match steps, and similarity of matching in the constructive concept script are the common knowledge in the field, and not the key point for constructing the embodiment of the present invention, therefore, the further description is not provided herein.

Furthermore, after activating the explorer 4 and the system, the system starts to search for the function keys of the explorer 4 to analyze or generate a constructive concept script to enable the user to use voice to control the explorer 4, for example, to open the webpage 41 under my favorite function, and start to search, to remark to analyze information in the webpage 41 for the user's voice control; after activating the explorer 4, the user can use voice control in functions and the hyperlink 412, and thus promote the convenience of surfing in the webpage 41. Before or after voice controlling the above the explorer 4, the function key operation, text key-in or filling up the information by voice control are functional. These descriptions are merely for demonstrating the embodiment of the present invention, and are not intended for limiting the scope of present invention. Any illustrative or modification shall be construed to be within the scope of the present invention.

The present invention has at least the following advantages.

1. After remarking number or color to the plurality of texts 411, the hyperlink 412 of the webpage 41 linking by the explorer 4, the user only has to speak out the number, color or keyword corresponding to the hyperlink 412, the webpage 41 automatically executes to link to the webpage 41 in the hyperlink 412 to provide convenience to the user to view the webpage 41 by using the explorer 4.

2. Keyword can be retrieved by analyzing before remarking the plurality of texts 411 and the hyperlink 412 of the webpage 41, and the color remark can be done only on the keyword in the text 411, thus the user need not finish reading the whole text 411 while searching for the information from the plurality of texts 411 in the webpage 41, and according the time to view in the webpage 41 can be reduced.

3. After the explorer 4 links to the webpage 41, the user can directly speak out the keyword to make the webpage 41 to automatically link to the webpage 41 of the hyperlink 412, the user can spend less time for searching the hyperlink 412 from the webpage 41, and accordingly, the user's eyesight can be protected due to short time viewing of the monitor.

The system and the method for searching the webpage by the voice control in the present invention include remarking the plurality of texts 411 and the hyperlink 412 in the webpage 41 to facilitate search in the explorer 4 and generate the constructive concept script representing the commands, wherein the user speaks out the word, and the voice signal is received to identify the constructive concept script for matching process, after finding the corresponding remark, the command linking to the constructive concept script from matching with the database can be executed to open the webpage of the hyperlink, and thus to provide convenience to the user to view the webpage 41. These descriptions are merely for demonstrating the embodiment of the present invention, and are not intended for limiting the scope of the present invention. Any illustrative or modification shall be construed to be within the scope of the present invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A method for operating a system for searching a webpage by voice control: including a user speaking out to operate an explorer to link to a webpage corresponding to a hyperlink displayed in said webpage; a natural language processing module connected to a voice identification module and said explorer, wherein said voice identification module is connected to a sound receiving device for receiving a user's voice; said explorer opens said webpage containing a plurality of texts and said hyperlink; the method comprising the following steps:
(A) starting said system;
(B) searching said plurality of texts with said hyperlink;
(C) remarking said texts with said hyperlink;
(D) analyzing a constructive concept script representing said hyperlink commands;
(E) receiving a voice signal;
(F) identifying said voice signal;
(G) matching according to said constructive concept script; and
(H) searching for corresponding remarks, executing a command linking to said constructive concept script according to a matching with information stored in a database to open a corresponding said hyperlink said webpage.

2. A method for operating a system for searching a webpage by voice control according to claim 1, wherein said step (C) of remarking includes designating a number at a side of said text, a background color of said text or color of a keyword.

3. A method for operating a system for searching a webpage by voice control according to claim 1, wherein a user speaks out said number, said color or said keyword which is received by said sound receiving device.

4. A method for operating a system for searching a webpage by voice control according to claim 1, wherein said constructive concept script and said hyperlink command generated after analysis are stored in a database.

5. A method for operating a system for searching a webpage by voice control according to claim 1, wherein said step (D) of analyzing constructive concept script representing hyperlink commands comprises:
(D1) checking a sentential form, and verifying whether text qualify a particular form;
(D2) segmenting words and processing segmented words for the text;
(D3) classifying according to a professional field for providing an attribution of the text after word segmentation;
(D4) checking a keyword set, and determining from every text after word segmentation whether any keyword set exist for displaying the key requirement in two major classifications, one representing a specific event or background, the other representing various criteria of the information;
(D5) checking for a synonymy or a synonymy set, and determining whether the synonymy of a professional terminology or the synonymy set of the keyword set exist in the text; and
(D6) generating a constructive concept script representing the user's inquiry.

6. A method for operating a system for searching a webpage by voice control according to claim 1, wherein said step (G) to convert voice into a text information, and a natural language processing module analyzes and converts said text information into a constructive concept script, and match according to said constructive concept script of said voice with a corresponding constructive concept script in a database comprises the following steps:
(G1) searching for an identical or similar constructive concept script from the database;
(G2) searching a professional terminology lexicon of every constructive concept script from the database according to the professional terminology of the constructive concept script generated by the voice signal;
(G3) searching for a related keyword set from the database according to the resulting professional terminology;
(G4) searching all key events and criteria according to the resulting keyword set; and
(G5) retrieving a most likely matching constructive concept script according to all the related key events and criteria.
